(19) United States
(12) Patent Application Publication
(10) Pub. No.: US 2019/0325094 A1
(43) Pub. Date: Oct. 24, 2019

(54) SYSTEM AND METHOD FOR AUTOMATING THE CREATION OF MACHINE LEARNING BASED HARDWARE AND SOFTWARE COMPONENT SIMULATORS

(71) Applicant: VCE IP Holding Company LLC, Hopkinton, MA (US)

(72) Inventors: Arthur Oren Beall III, Sachse, TX (US); Shashank Holakkal, Plano, TX (US)

(21) Appl. No.: 15/961,196

(22) Filed: Apr. 24, 2018

(51) Int. Cl. G06F 17/50; G06N 99/00

(52) U.S. Cl. CPC G06F 17/5009; G06N 99/005

(57) ABSTRACT

A computing device for simulating a component includes a communication interface to a client and a component simulator. The component simulator includes a functional relationship based on training data obtained from the component using a communication protocol. The component simulator obtains a message via the communication interface from a second client using the communication protocol; generates a simulated response to the message using the functional relationship; and sends the simulated response via the communication interface using the communication protocol.

### BACKGROUND

Computing devices may include any number of internal components such as processors, memory, and persistent storage. Each of the internal components of a computing device may need to be compatible with each other for the computing devices to operate. Similarly, components of computing devices operably connected with each other may need to be compatible with each other.

### SUMMARY

In one aspect, a method of simulating a component in accordance with one or more embodiments of the invention includes obtaining a training data set comprising communications between a component and a client using a communication protocol; generating a functional relationship between a first portion of the communications sent by the client and a second portion of the communications sent by the component; generating a component model using the generated functional relationship; and populating a component simulator using the component model.

In one aspect, a computing device for simulating a component in accordance with one or more embodiments of the invention includes a communication interface to a client and a component simulator. The component simulator includes a functional relationship based on training data obtained from the component using a communication protocol. The component simulator obtains a message via the communication interface from a second client using the communication protocol; generates a simulated response to the message using the functional relationship; and sends the simulated response via the communication interface using the communication protocol.

In one aspect, a non-transitory computer readable medium in accordance with one or more embodiments of the invention includes computer readable program code, which when executed by a computer processor enables the computer processor to perform a method for simulating a component, the method includes obtaining a training data set comprising communications between a component and a client using a communication protocol; generating a functional relationship between a first portion of the communications sent by the client and a second portion of the communications sent by the component; generating a component model using the generated functional relationship; and populating a component simulator using the component model.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of an example component simulator in accordance with one or more embodiments of the invention.

FIG. 3A shows a flowchart of a method of generating a component simulator in accordance with one or more embodiments of the invention.

FIG. 3B shows a flowchart of a method of obtaining training data in accordance with one or more embodiments of the invention.

FIG. 3C shows a flowchart of a method of selecting a machine learning algorithm in accordance with one or more embodiments of the invention.

FIG. 3D shows a flowchart of a method of generating a component model in accordance with one or more embodiments of the invention.

FIG. 4A shows a diagram of an example system.

FIG. 4B shows a diagram of a data center of the example system of FIG. 4A.

FIG. 4C shows a diagram of a second data center of the example system of FIG. 4A.

FIG. 4D shows a diagram of a third data center of the example system of FIG. 4A.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for simulating a component. The component may be a component of a computing device. The component may be, for example, a solid state disk drive, a memory module, or a network adapter. The component may be other types of components without departing from the invention.

In one or more embodiments of the invention, the system may include a component simulator that emulates the responses to messages a simulated component would generate. By emulating the responses, the component simulator may present the behavior of the simulated component to another component to test the compatibility of the components, or for other reasons.

In one or more embodiments of the invention, the component simulator includes a component model. The component model may be generated using machine learning. The machine learning may identify a relationship between message sent to a to-be-simulated component and the response generated. The component model may use the identified relationship to generated simulated responses. In turn, the component simulator may send the generated responses to another component in response to a received message.

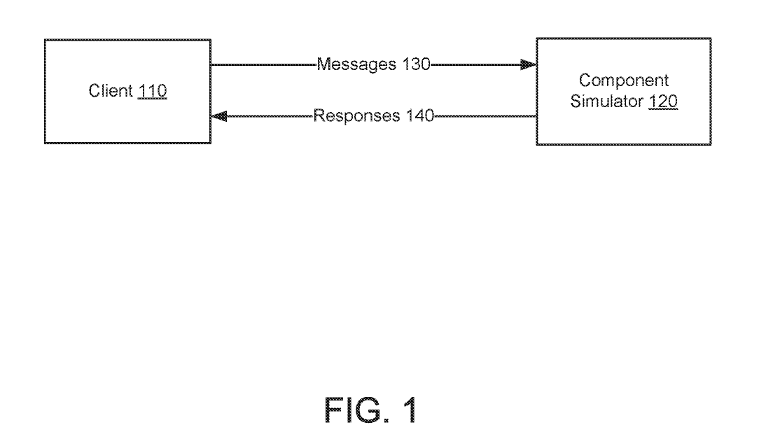

FIG. 1 shows a diagram of a system in accordance with one or more embodiments of the invention. The system may include a client (110) and a component simulator (120). The client (110) may send and receive communications from the component simulator (120). The communications may be messages (130) sent from the client (110) to the component simulator (120) and responses (140) sent from the component simulator (120) to the client (110). The responses generated by the component simulator (120) may mimic the responses that an actual component that the component simulator (120) is emulating would send in response to the messages (130) from the client (110). Each component of the system is discussed below.

In one or more embodiments of the invention, the client (110) sends communications to the component simulator (120) using a communication protocol. The messages (130) may include any data or other content. The component simulator (120) may emulate the responses of an actual component based on the messages (130).

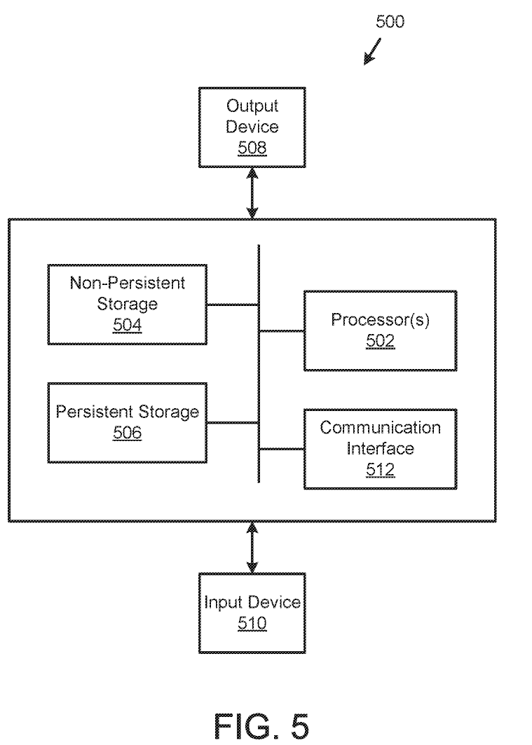

In one or more embodiments of the invention, the client (110) is a computing device. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the client (110) described throughout this application. For additional details regarding computing devices, See FIG. 5.

In one or more embodiments of the invention, the component simulator (120) simulates the behavior of a component. The component simulator (120) may simulate the behavior of a component by sending responses (140) that are the same as responses the component would send if the messages (130) were sent to the component.

In one or more embodiments of the invention, the component emulated by the component simulator (120) is a hardware component. The hardware component may be, for example, a solid state disk, a hard drive, a router, or other type of component without departing from the invention.

In one or more embodiments of the invention, the component emulated by the component simulator (120) is a software component. The software component may be, for example, a virtual machine, a database, etc.

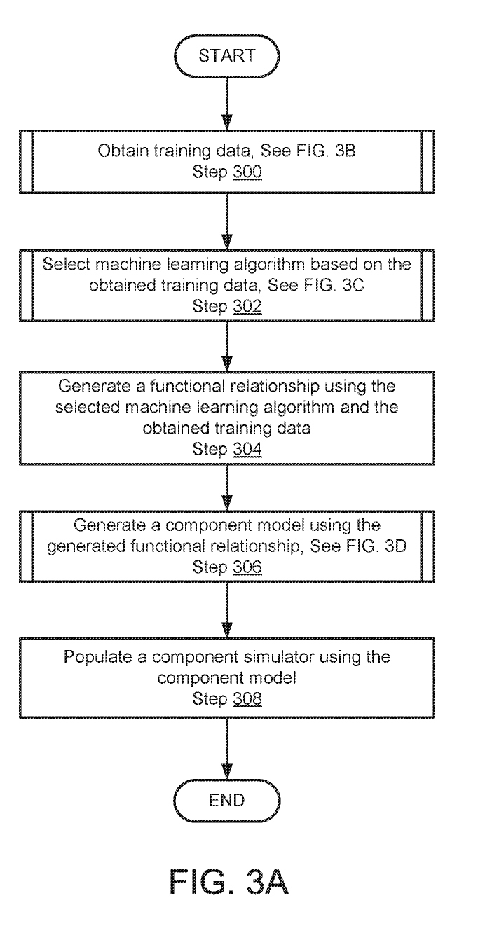

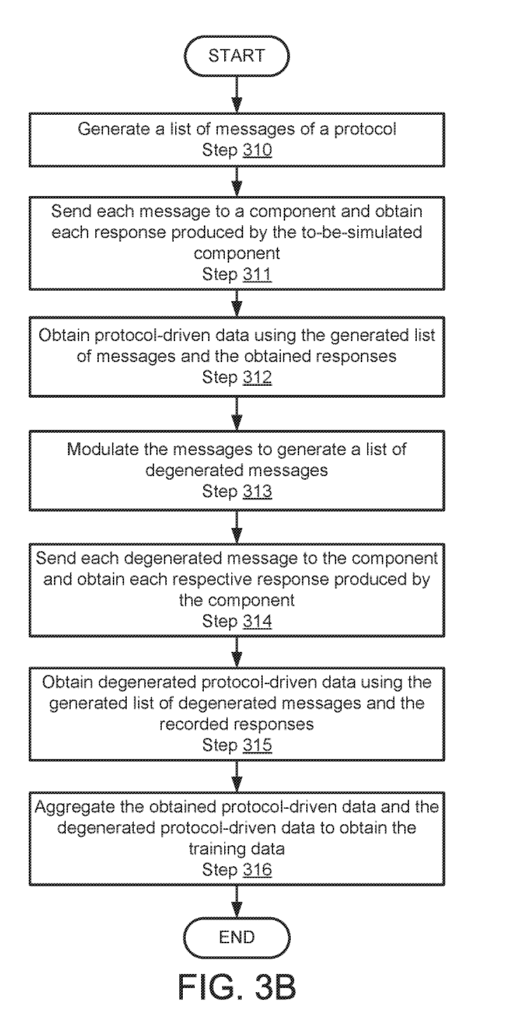

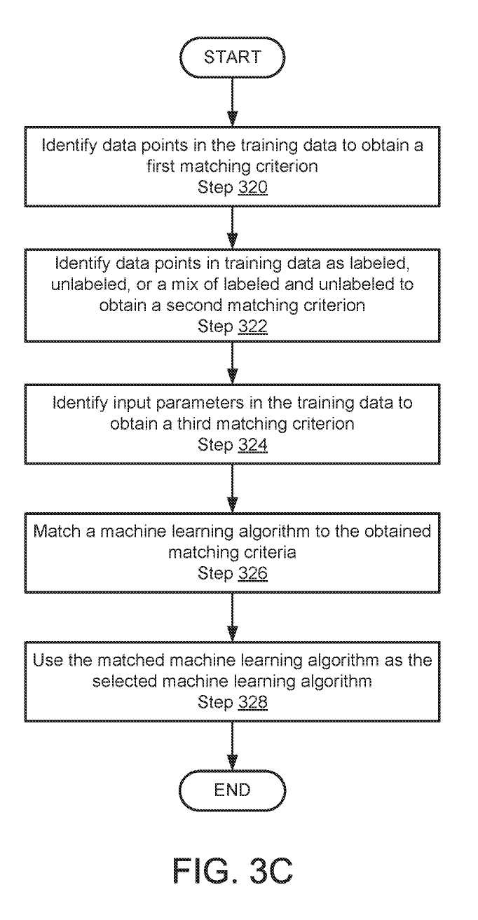

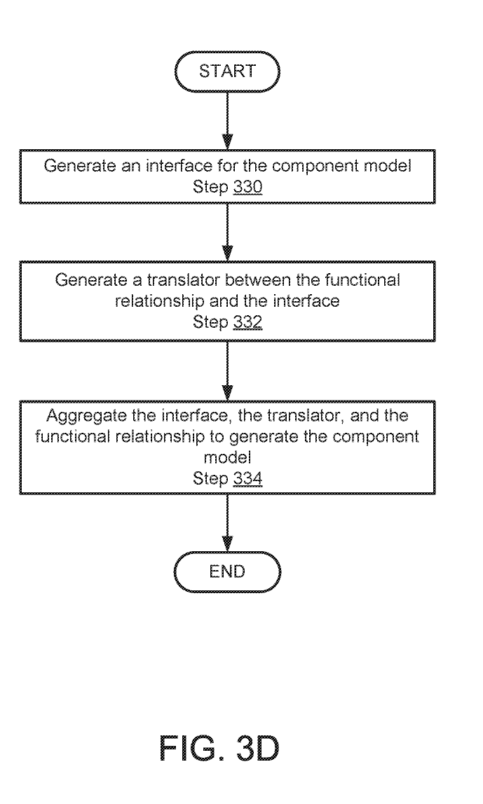

In one or more embodiments of the invention, the component simulator (120) is generated via the method illustrated in FIGS. 3A-3D.

In one or more embodiments of the invention, the component simulator (120) is a computing device. The computing device may include processors, memory, storage, and interfaces. The computing device may be programmed to provide the functionality of the component simulator (120) discussed throughout this application and/or all, or a portion thereof, of the methods shown in FIGS. 3A-3D. For additional details regarding computing devices, See FIG. 5.

In one or more embodiments of the invention, the component simulator (120) is a virtual machine. The virtual machine may be programmed to provide the functionality of the component simulator (120) discussed throughout this application and/or all, or a portion thereof, of the methods shown in FIGS. 3A-3D. The virtual machine may use computing resources of other devices to provide the functionality fo the component simulator (120).

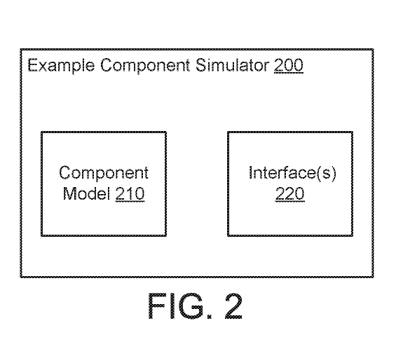

To further clarify aspects of the invention, FIG. 2 shows a diagram of an example component simulator (200) in accordance with one or more embodiments of the invention. The example component simulator (200) may be the same as the component simulator (120) of FIG. 1. As discussed above, the example component simulator (200) may simulate the behavior of a component. The behavior may include obtaining a message, processing the message, and sending a response. To provide the aforementioned functionality, the example component simulator (200) may include a component model (210) and interfaces (220). Each portion of the example component simulator (200) is discussed below.

In one or more embodiments of the invention, the component model (210) simulates the behavior of a component. More specifically, the component model (210) simulates the behavior of the component by generating responses to messages that the component would generate. The generated responses may then be sent via the interfaces (220). The interfaces (220) may be physical, e.g., wires, or virtual, e.g., a virtual interface.

To generate the example component simulator (200), either a computing device or virtual machine may be populated using information derived from communications with a to-be-simulated component. FIGS. 3A-3D show methods of generating a component simulator.

FIG. 3A shows a flowchart of a method in accordance with one or more embodiments of the invention. The method depicted in FIG. 3A may be used to populate a component simulator in accordance with one or more embodiments of the invention. The method shown in FIG. 3A may be performed by, for example, a computing device (not shown).

In Step 300, training data is obtained.

In one or more embodiments of the invention, the training data is based on communications made by the to-be-simulated component. For example, communications between the to-be-simulated component and a second component may be monitored.

In one or more embodiments of the invention, the training data is obtained via the method illustrated in FIG. 3B. The training data may be obtained via other methods without departing from the invention.

In Step 302, a machine learning algorithm is selected based on the obtained training data.

In one or more embodiments of the invention, the machine learning algorithm is a method for determining a functional relationship between each message that is sent to a to-be simulated component and response that would be sent by the to-be-simulated component.

For example, a machine learning algorithm may include applying a least-squares approach to generate a linear regression between a message and a response. The least squares approach may include treating each message-response pairs as quantitative data points, with each message and response corresponding to a value. The method of generating a linear regression using the least squares approach may include minimizing the sum of squared residuals. A squared residual may be the square of the difference between the value of a response and a predicted value generated by a linear function. The linear function may include parameters, such as a slope and intercept, that, when calculated, define the linear function.

In one or more embodiments of the invention, the machine learning algorithm is selected by identifying criteria of the training data. The criteria may include the number of data points in the training data, the identifying whether the data points are labeled, unlabeled, or a mix of labeled and unlabeled, and identifying the number of parameters of the data points.

In one or more embodiments of the invention, the machine learning algorithm is selected via the method illustrated in FIG. 3C. The machine learning algorithm may be selected via other methods without departing from the invention.

In Step 304, a functional relationship is generated using the selected machine learning algorithm and the obtained training data.

In one or more embodiments of the invention, the functional relationship is generated by applying the selected machine learning algorithm to the obtained training data. The functional relationship may be, for example, an equation that relates an input message value to a response value. Alternatively, the functional relationship may be, for example, a decision diagram that determines a response according to parameters of the message.

In Step 306, a component model is generated using the generated functional relationship.

In one or more embodiments of the invention, the component model uses the functional relationship to send a simulated response corresponding to an obtained message. In one or more embodiments of the invention, the component model includes one or more interfaces that provide operable connections between the component model and computing devices or other entities. The component model may include a translator that converts the response specified by the functional relationship to a format that is compatible with a protocol through which the simulated response will be transmitted to another entity.

In one or more embodiments of the invention, the component model is generated using the method illustrated in FIG. 3D. The component model may be generated using other methods without departing from the invention.

In Step 308, a component simulator is populated using the component model.

In one or more embodiments of the invention, the component simulator is populated by storing the component model in a hardware device, e.g., a computing device. The hardware device may include one or more interfaces, an operable connection to support communications, and other digital signal processing hardware such as, for example, programmable gate arrays, digital signal processors, and/or application specific integrated circuits.

The method may end following Step 308.

FIG. 3B shows a flowchart of a method in accordance with one or more embodiments of the invention. The method depicted in FIG. 3B may be used to obtain training data in accordance with one or more embodiments of the invention. The method shown in FIG. 3B may be performed by a computing device. Other components of the system illustrated in FIG. 1 may perform the method of FIG. 3B without departing from the invention.

In Step 310, a list of messages of a protocol is generated.

In one or more embodiments of the invention, the list of messages is generated by enumerating a communication protocol. In other words, a client, or other computing device, may generate a list of every message that may be sent that is within a protocol established by the client, the to-be-simulated component, or another computing device.

In Step 311, each message of the list is sent to a component and each respective response produced by the to-be-simulated component is obtained.

In one or more embodiments of the invention, the client, or other computing device, sends each message from the generated list of messages to the component and obtains the response. The message and corresponding response may be stored as a message-response pair.

In Step 312, protocol-driven data is obtained using the generated list of messages and the obtained responses.

In one or more embodiments of the invention, the protocol-driven data is a collection of the message-response pairs generated in Step 311.

In Step 313, the messages of the list are modulated to generate a list of degenerated messages.

In one or more embodiments of the invention, a degenerated message is a message that is not within the protocol established by the client, the to-be-simulated component, or another computing device. The degenerated message sent to a component may cause the component to send a response that is not within the established protocol.

In one or more embodiments of the invention, a message is modulated using the method of single bit flipping. Single bit flipping may be the changing of a bit from a message from a 1 to a 0, or the reverse. A message may be digital data that includes an array of binary numbers. A message within an established protocol may be modulated to obtain a degenerated message by switching a bit in the array of binary numbers from a 1 to a 0, or from a 0 to a 1.

In one or more embodiments of the invention, a message is modulated by removing a cluster of bits from the message. A cluster of bits may be a portion of the message. A message within the established protocol may be modulated to be a degenerated message by removing one or more portions from the message.

In one or more embodiments of the invention, a message is modulated by selecting a portion of the message and selecting a portion of a second message and juxtaposing the respective portion of the first message with the portion of the second message and vice versa.

In one or more embodiments of the invention, the degenerated messages are aggregated to generate a list of degenerated messages.

In Step 314, each degenerated message is sent to the to-be-simulated component, and each respective response produced by the to-be-simulated component is obtained.

In Step 315, degenerated protocol driven data is obtained using the generated list of degenerated messages and the obtained responses.

In one or more embodiments of the invention, the degenerated protocol-driven data is a collection of degenerated message-response pairs generated using the degenerated messages and the obtained responses.

In Step 316, the obtained protocol-driven data and the obtained degenerated protocol driven data are aggregated to obtain the training data.

The method may end following Step 316.

FIG. 3C shows a flowchart of a method in accordance with one or more embodiments of the invention. The method depicted in FIG. 3C may be used to select a machine learning algorithm in accordance with one or more embodiments of the invention. The method shown in FIG. 3C may be performed by, for example, a computing device. Other components of the system illustrated in FIG. 1 may perform the method of FIG. 3C without departing from the invention.

In Step 320, data points are identified in the training data to obtain a first matching criterion.

In one or more embodiments of the invention, a machine learning algorithm is determined by identifying how many data points are in the training data. In one or more embodiments of the invention, a data point is a message-response pair in the training data.

In one or more embodiments of the invention, the number of data points in the training data is a criterion for the selected machine learning algorithm. A machine learning algorithm, such as, for example, a least absolute shrinkage and selection operator, may be selected for training data with a small number of data points. In contrast, training data with a large number of data points may not select the least absolute shrinkage and selection machine learning algorithm due to the machine learning algorithm using a large amount of computation resources.

A machine learning algorithm may be selected if the number of data points in the training data is within a range of number of data points that the machine learning algorithm may utilize to generate a functional relationship. The range of numbers may be, for example, more than 100,000 data points, less than 100,000 data points, or any other range without departing from the invention.

In one or more embodiments of the invention, an example of a machine learning algorithm that may function with training data greater than 100,000 data points is the least squares approach discussed above.

In Step 322, data points are identified in the training data as labeled, unlabeled, or a mix of labeled and unlabeled to obtain a second matching criterion.

In one or more embodiments of the invention, a labeled data point is a message response pair that includes both a message and response. In contrast, an unlabeled data point may be a message in the training data that does correspond to a response. A machine learning algorithm uses both the message and the response in the training data to generate a functional relationship. However, one or more machine learning algorithms may be capable of generating a functional relationship using training data that includes messages and no responses. Additionally, one or more machine learning algorithms may be capable of generating a functional relationship using training data that includes a mix of labeled data points and unlabeled points.

In Step 324, input parameters are identified in the training data set to obtain a third matching criterion.

In one or more embodiments of the invention, an input parameter is a property of the messages in the training data. Properties of messages may include, for example, an amount of data in the message, an identifier of data packets in the message, the content of the message, and/or other properties without departing from the invention. A machine learning algorithm may be selected by identifying the number of input parameters of the messages.

In Step 326, a machine learning algorithm is matched to the obtained matching criteria.

In one or more embodiments of the invention, one or more machine learning algorithms are evaluated to determine if the machine learning algorithms meet the first, second, and third matching criteria discussed above.

In Step 328, the matched machine learning algorithm is used as the selected machine learning algorithm.

The method may end following Step 328.

FIG. 3D shows a flowchart of a method in accordance with one or more embodiments of the invention. The method depicted in FIG. 3D may be used to generate a component model in accordance with one or more embodiments of the invention. The method shown in FIG. 3D may be performed by, for example, a computing device. Other components of the system illustrated in FIG. 1 may perform the method of FIG. 3D without departing from the invention.

In Step 330, an interface is generated for the component model.

In Step 332, a translator between the functional relationship and the interface is generated.

In Step 334, the interface, the translator, and the functional relationship are aggregated to generate the component model.

The method may end following Step 334.

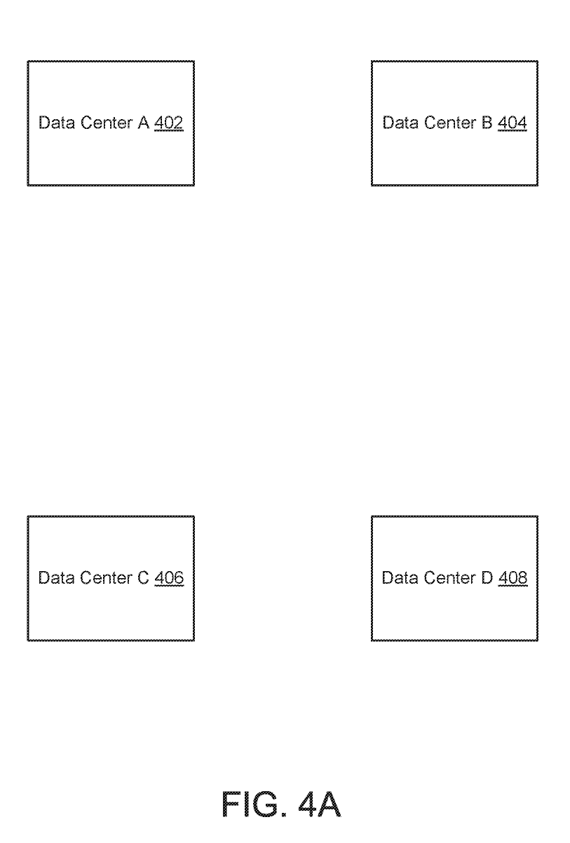

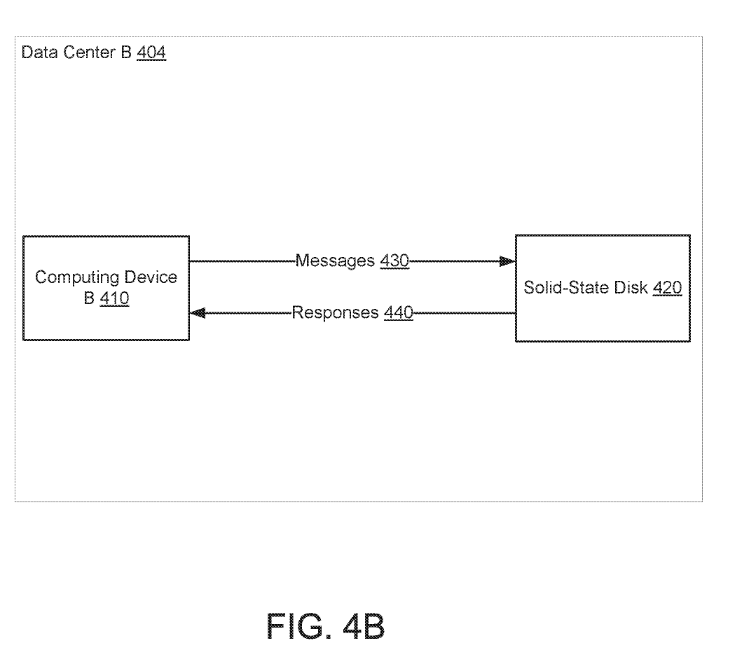

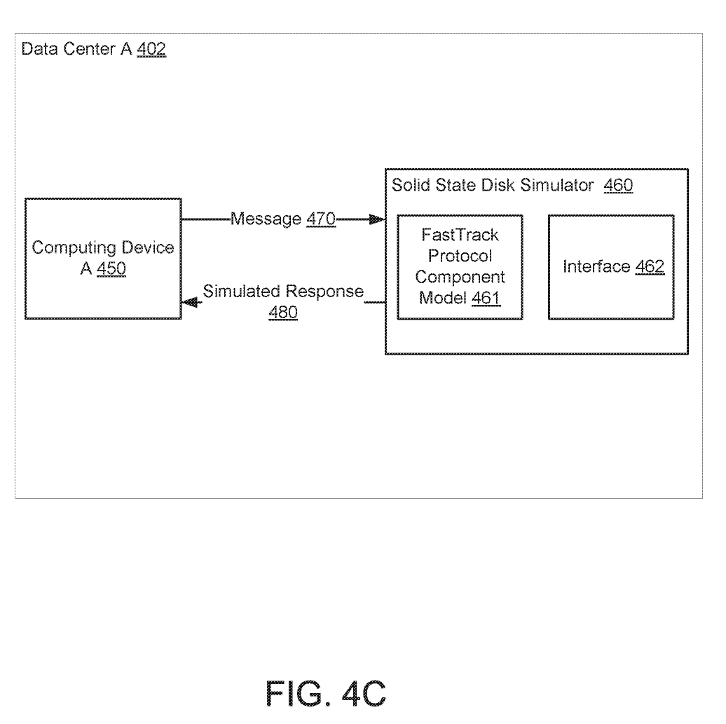

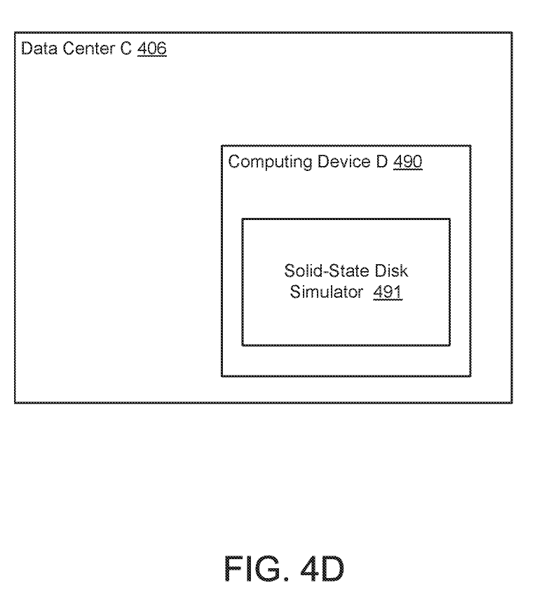

To further clarify embodiments of the invention, a non-limiting example is provided below and illustrated in FIGS. 4A-4D.

### Example 1

Consider a scenario in which there are four data centers in different geographic locations. FIG. 4A shows a diagram of four data centers (402, 404, 406, 408) that are not operably connected. Data centers A-D (402, 404, 406, 408) may each benefit from testing the functionality of a new generation solid-state disk. Because not every data center (402, 404, 406, 408) may have access to the new generation solid state disk, a solid-state disk simulator may be created to allow data centers (402, 404, 406, 408) to test the functionality of the new generation solid-state disk. The solid-state disk simulator may include a component model that sends and receives communications to a computing device while following a FastTrack protocol.

FIG. 4B shows the new generation solid-state disk (420) operably connected to a computing device B (410). The solid-state disk (420) may be located in data center B (404). Computing device B (410) may generate a component simulator to simulate the behavior of the solid-state disk (420). Computing device B (410) may generate a component simulator by obtaining messages (430) and responses (440) that correspond to each message (430). Each message and corresponding response may be a message-response pair.

Computing device B (410) may enumerate a communications protocol to generate a list of protocol-driven messages within a communications protocol established between computing device B (410) and the solid-state disk (420). The communications protocol may be a FastTrack protocol. The protocol-driven messages may be sent to the solid-state disk (420), and the response to each protocol-driven message may be recorded. The protocol-driven messages and the responses may be protocol-driven data.

Computing device B may modulate the protocol-driven messages by applying the method of single bit flipping to each protocol-driven message. As discussed above, single bit flipping may be selecting a bit from data, such as the protocol-driven messages, and switching the value of the bit from a 1 to a 0, or from a 0 to a 1. The process of single bit switching may be applied to each protocol-driven message to generate degenerated messages. The degenerated messages may be sent to the solid-state disk (420). Computing device B (410) may record the response to each degenerated message. The degenerated messages and the responses may be degenerated protocol-driven data.

The protocol-driven data and the degenerated protocol-driven data may be aggregated to obtain training data.

The training data may be used to select a machine learning algorithm. The number of message-response pairs in the training data may be identified as 1,000,000. The number of message-response pairs may be a first matching criterion for selecting a machine learning algorithm. A second matching criterion may include identifying the training data as labeled. The training data may be labeled because every message-response pair in the training data includes both a message and a response. In other words, there is no message in the training data that does not have a corresponding response. A third matching criterion may include identifying input parameters of the messages in the training data. Each message may be binary data that corresponds to a numerical value. The value of each message may be an input parameter.

A machine learning algorithm may be selected by matching the machine learning algorithm to the first, second, and third matching criteria. A machine learning algorithm that meets the matching criteria may be the least squares regression machine learning algorithm.

The least squares regression machine learning algorithm may be applied to the training data to generate a functional relationship. The functional relationship may include information about a response to a message. The functional relationship may be used to generate a component model.

FIG. 4C shows a diagram of the solid-state disk simulator (460) operably connected to computing device A (450) in data center A (402). The solid-state disk simulator (460) includes a FastTrack protocol component model (461) and an interface (462). Computing device A (450) may send a message (470) to the solid-state disk simulator (460). The solid-state disk simulator (460) may send a simulated response (480) to computing device A.

The interface (462) may be used to allow the solid-state disk simulator (460) to communicate with computing device A (450). The interface (462) may be a port that allows computing device A (450) to physically connect to the solid-state disk simulator (460) via wired connections.

The FastTrack protocol component model (461) may include the functional relationship. The FastTrack protocol component model (461) may use the functional relationship to generate the simulated response (480) corresponding to the message (470) obtained.

The solid-state disk simulator (4600 in data center A (402) may be a hardware component, such as a computing device. FIG. 4D shows a diagram of a solid-state disk simulator (491) stored as a software component, e.g., virtual machine running on computing device D (49) in data center C (406). The solid-state disk simulator (491) may be stored in computing device D (490).

### End of Example 1

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may improve the compatibility of computing devices and components therein. More specifically, embodiments of the invention may provide for the simulation of components and thereby enable testing of new components to be performed rapidly. For example, it may be prohibitively expensive to obtain multiple copies of a new generation component. To improve compatibility and expedite compatibility testing, embodiments of the invention may provide a method of simulating a computing device based on machine learning. A component simulator may be populated using a relationship based on messages sent to and responses obtained from a to-be-simulated component. In this manner, a component simulator may be generated that emulates the behavior of an otherwise limited availability component.

Thus, embodiments of the invention may address the problem of compatibility between new components and old components. This problem arises due to the technological nature of the environment. Accordingly, embodiments of the invention may directly address problems that arise due to the use of computing devices.

While embodiments of the invention have been described as addressing one or more problems, embodiments of the invention are applicable to address other problems and the scope of the invention should not be limited to addressing the problems specifically discussed throughout this application.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method of simulating a component, comprising:
obtaining a training data set comprising communications between a component and a client using a communication protocol;
generating a functional relationship between a first portion of the communications sent by the client and a second portion of the communications sent by the component;
generating a component model using the generated functional relationship; and
populating a component simulator using the component model.

2. The method of claim 1, wherein obtaining the training data set comprising the communications between a component and a client using a communication protocol comprises:
obtaining a plurality of protocol driven message-response pairs;
obtaining a plurality of protocol driven degenerated message-response pairs;
aggregating the plurality of protocol driven message-response pairs and the plurality of protocol driven degenerated message-response pairs to obtain the communications.

3. The method of claim 2, wherein obtaining the plurality of protocol driven message-response pairs comprises:
enumerating a client side of the communication protocol;
generating a plurality of messages using the enumerating a client side of the communication protocol;
obtaining a plurality of responses from the component using the plurality of messages; and
generating the plurality of protocol driven message-response pairs using:
the plurality of messages, and
the plurality of responses.

4. The method of claim 3, wherein obtaining the plurality of protocol driven message-response pairs comprises:
enumerating a client side of the communication protocol;
generating a plurality of messages using the enumerating a client side of the communication protocol;
degenerating the plurality of messages to obtain a plurality of degenerated messages;
obtaining a plurality of responses from the component using the plurality of degenerated messages; and
generating the plurality of protocol driven degenerated message-response pairs using:
the plurality of degenerated messages, and
the plurality of responses.

5. The method of claim 4, wherein degenerating the plurality of messages comprises:
selecting a bit of a message of the plurality of messages; and
flipping the selected bit.

6. The method of claim 4, wherein degenerating the plurality of messages comprises:
selecting a first message of the plurality of messages;
selecting a second message of the plurality of messages; and
replacing a portion of the first message with a portion of the second message.

7. The method of claim 1, further comprising:
before generating the functional relationship:
matching the communications to a machine learning algorithm of a plurality of machine learning algorithms.

8. The method of claim 7, wherein the matching is based on a cardinality of the communications.

9. The method of claim 7, wherein the matching is based on a cardinality of a client side of the communication protocol.

10. The method of claim 1, further comprising:
obtaining a message from a second client using the communication protocol;
generating a simulated response using the component simulator; and
sending the simulated response to the second client using the communication protocol.

11. The method of claim 1, wherein populating the component simulator using the component model comprises:
storing the component model in a hardware device,
where in the hardware device comprises an operable connection that supports the communication protocol.

12. The method of claim 1, wherein populating the component simulator using the component model comprises:
storing the component model in a virtual machine,
where in the virtual machine comprises virtual connection that supports the communication protocol.

13. A computing device for simulating a component, comprising:
a communication interface to a client; and
a component simulator comprising:
a functional relationship based on training data obtained from the component using a communication protocol,
wherein the component simulator is programmed to:
obtain a message via the communication interface from a second client using the communication protocol;
generate a simulated response to the message using the functional relationship; and
send the simulated response via the communication interface using the communication protocol.

14. The computing device of claim 13, wherein the training data comprises:
a plurality of protocol driven message-response pairs; and
a plurality of protocol driven degenerated message-response pairs.

15. The computing device of claim 14, wherein the plurality of protocol driven message-response pairs comprises:
a plurality of messages based on an enumeration of a client side of the communication protocol; and
a plurality of responses from the component obtained using the plurality of messages.

16. The computing device of claim 14, wherein the plurality of protocol driven degenerated message-response pairs comprises:
a plurality of degenerated messages based on an enumeration of a client side of the communication protocol; and
a plurality of responses from the component obtained using the plurality of degenerated messages.

17. A non-transitory computer readable medium comprising computer readable program code, which when executed by a computer processor enables the computer processor to perform a method for simulating a component, the method comprising:
obtaining a training data set comprising communications between a component and a client using a communication protocol;
generating a functional relationship between a first portion of the communications sent by the client and a second portion of the communications sent by the component;
generating a component model using the generated functional relationship; and
populating a component simulator using the component model.

18. The non-transitory computer readable medium of claim 17, wherein obtaining the training data set comprising the communications between a component and a client using a communication protocol comprises:
obtaining a plurality of protocol driven message-response pairs;
obtaining a plurality of protocol driven degenerated message-response pairs;
aggregating the plurality of protocol driven message-response pairs and the plurality of protocol driven degenerated message-response pairs to obtain the communications.

19. The non-transitory computer readable medium of claim 18, wherein obtaining the plurality of protocol driven message-response pairs comprises:
enumerating a client side of the communication protocol;
generating a plurality of messages using the enumerating a client side of the communication protocol;
obtaining a plurality of responses from the component using the plurality of messages; and
generating the plurality of protocol driven message-response pairs using:
the plurality of messages, and
the plurality of responses.

20. The non-transitory computer readable medium of claim 18, wherein obtaining the plurality of protocol driven message-response pairs comprises:
enumerating a client side of the communication protocol;
generating a plurality of messages using the enumerating a client side of the communication protocol;
degenerating the plurality of messages to obtain a plurality of degenerated messages;
obtaining a plurality of responses from the component using the plurality of degenerated messages; and
generating the plurality of protocol driven degenerated message-response pairs using:
the plurality of degenerated messages, and
the plurality of responses.
